(19) United States
(12) Patent Application Publication
(10) Pub. No.: US 2006/0291774 A1
(43) Pub. Date: Dec. 28, 2006

(54) Foil display

(76) Inventors: Volker Schoellmann, Eindhoven (CH); Tijsbert Mathieu Henricus Creemers, Nijmegen (NL); Peter Alexander Duine, Eindhoven (NL); Johannes Marra, Eindhoven (NL); Andrea Giraldo, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/550,883

(22) PCT Filed: Mar. 26, 2004
(86) PCT No.: PCT/IB04/50342

§ 371 Date: Sep. 27, 2005

(30) Foreign Application Priority Data
Apr. 2, 2003 (EP) 03100870.9

(51) Int. Cl. G02B 6/26

(52) U.S. Cl. 385/19; 345/85; 385/901

(57) ABSTRACT

A display device comprising a light guide (12), a back plate (14), a flexible element (15) arranged in between said light guide (12) and said back plate (14), and addressable electrodes (23) for inducing electrostatic forces on said element (15) a for bringing selected portions of said element (15) into contact with said light guide (12), in order to extract light from said light guide (12). The addressable electrodes (23) are arranged only on one of said light guide (12) and said back plate (14), and a biasing force acts on said flexible element (15) in a direction away from said addressable electrodes (23). The voltages required to operate the display will also be lower compared to the conventional foil display. In principle it is feasible to keep the electrode of the flexible element at ground potential while applying 10-20V pulses to the addressable electrodes to overcome the biasing force.

The present invention relates to a display device comprising a light guide, a back plate, a flexible element arranged in between said light guide and said back plate, and addressable electrodes for inducing electrostatic forces on said element and for bringing selected portions of said element into contact with said light guide, in order to extract light from said light guide.

Such displays are normally referred to as foil displays.

A conventional foil display (see e.g. WO00/38163) comprises a light guide in the form of an edge-lit glass plate and a non-lit back plate, with a scattering foil clamped in between these two plates. On both plates there are respective sets of parallel electrodes which are arranged perpendicular with respect to each other. A common foil electrode is present on one side of the scattering foil and covers the entire surface area of said side. By application of voltages to appropriate electrodes on the light guide, the back plate, and the foil, it is possible to generate two opposing electrostatic forces onto the foil with the force vectors directed towards the light guide and the back plate, respectively. The balancing of these two opposing electrostatic forces in combination with the elastic force of the foil is used to attract the foil to either the light guide or the back plate. A net attractive force between the foil and a row or column electrode induces foil switching towards that electrode if the foil was initially not in contact with that electrode. Typically, the foil can be locally attracted towards the light guide by imposing a voltage difference between the local column electrode and the foil electrode that is, in absolute terms, larger than the imposed voltage difference between the local row electrode and the foil electrode. Similarly, the foil can be locally attracted towards the back plate by imposing a voltage difference between the local row electrode and the foil electrode that is, in absolute terms, larger than the imposed voltage difference between the local column electrode and the foil electrode.

Since the forces of attraction (Coulomb forces) exerted onto the foil towards the row-and the column electrode are furthermore proportional to the inverse of the “effective” distance between the respective electrode and the foil electrode (i.e. taking into account the dielectric constant of the layers between the electrode and the foil conductor), there is a hysteresis in the foil switching behavior. This hysteresis accounts for a bi-stable foil switching behavior: If pixels are not selected by a row voltage, the foil sections associated with those pixels will not switch—independent of whether or not a voltage pulse of a given height is applied to the corresponding column electrode. Since such a bi-stable region exists, there is a memory effect in the pixels and, therefore, a passive matrix addressing scheme can be used to drive the display.

A crucial feature of the conventional foil display are sets of matching spacers on both plates. In between these spacers the foil is clamped, and a gap is defined between the foil and the two plates.

Shortcomings of the currently observed performance with the design outlined above are:
requirement for high addressing voltages, foil voltage typically 50-80V, select pulses on row and column electrodes approximately 10-20V;
variation in the extent and reproducibility of the foil switching bistability existing in different pixels;
large number of unwanted pixel switching events during addressing.

The object of the present invention is to overcome or mitigate at least some of these shortcomings, and to provide a foil display having an improved and more reliable addressing and switching behavior of the flexible element.

According to the invention, this object is achieved by a foil display of the kind mentioned by way of introduction, wherein only one of the light guide and the back plate is provided with addressing electrodes, and wherein a biasing force acts on the flexible element in a direction away from said addressable electrodes.

Note that the biasing force acts on essentially the entire flexible element. The addressing electrodes are each capable of addressing a portion of the flexible element, such as an individual pixel or a row of pixels, and to create an electrostatic force on this portion, locally overcoming the biasing force.

However, the flexible element now only needs to be displaced between two positions without having to rely on a foil switching bistability. In the conventional foil display, the flexible element must be displaced between two extreme positions while relying on the existence of a given degree of foil switching bistability, i.e. on the existence of a bi-stable region in the foil switching diagram. A foil switching diagram gives the foil position in a pixel as a function of the applied voltage difference between the column electrode and the foil electrode on the one hand, and the applied voltage difference between the row electrode and the foil electrode on the other hand.

The foil display layout can thus be optimized such as to minimize the existing foil switching bistability and to be compatible with active matrix addressing (see below). Consequently, the voltages required to operate the display will also be lower compared to the conventional foil display. In principle it is feasible to keep the electrode of the flexible element at ground potential while applying 10-20V pulses to the addressable electrodes in order to overcome the biasing force. For these voltage ranges the driver electronics is simpler, and likely to be commercially available.

Preferably, active matrix addressing is used to address the addressable electrodes.

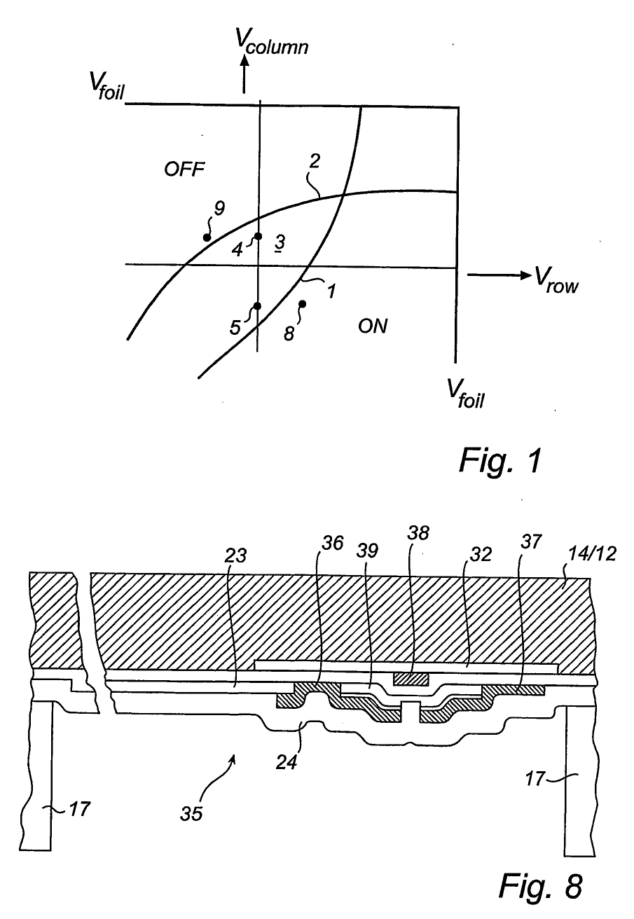

FIG. 1 shows a foil switching diagram of a conventional foil display. An “ON”-curve 1 and an “OFF”-curve 2 define a bi-stable region 3 in between them, e.g. an area of foil switching hysteresis. This is a required situation for passive matrix addressing, and the operating area of a not row-selected pixel (points 4 and 5) has to be located inside this bi-stable region 3. A change of column voltage only alternates the pixel between the points 4 and 5, without changing the foil switching state. In order to switch the pixel into the ON state, the row voltage must be set low (closer to the foil voltage) and the column voltage must be set high, i.e. further away from the foil voltage (point 8). Conversely, in order to switch the pixel into the OFF state, the row voltage must be set high (further away from the foil voltage) and the column voltage set low, i.e. closer to the foil voltage (point 9). Alternatively, the pixel is turned OFF by setting the column voltage even lower than in point 4, e.g. equal to the foil voltage, a so called robust switch off. In any case, it is clear from FIG. 1 that three voltage levels are required on either the column or row driver. Furthermore, several operating points are located in the bi-stable region, and the foil switching performance is therefore sensitive to variations in the precise location of the ON curve 1 and the OFF curve 2 in the foil switching diagrams associated with different pixels (pixel-pixel foil switching spread), as well as to static charging.

In using active matrix addressing the pixel memory is instead provided by the pixel circuit instead. If a select pulse is given, a voltage can be stored on the pixel circuit, which defines whether a pixel is switched “on” or “off”. Thus only two levels are needed, one in the ON region (i.e. below both the ON curve 1 and the OFF curve 2), and one in the OFF region (i.e. above the ON curve 1 and the OFF curve 2). As a consequence, the drivers can be simplified.

Also, an increase in the pixel-pixel foil switching spread because of bistability variations between pixels will merely require a larger voltage swing of the drivers, but not necessarily to non-addressable pixels, which is a risk with PM addressing. Even horizontal (i.e. the switching is independent of the row voltage) or vertical (independent of the column voltage) switching curves would offer good performance. Since the two operating points in the foil switching diagram can now be chosen with a large degree of freedom, a small voltage swing between the pixel-ON and pixel-OFF operating points as well as a maximized contact interface between the foil and the light guide in an ON pixel should be aimed at.

An additional advantage is that the addressing pulse length can be substantially reduced with AM addressing. In PM addressing the pulse has to be maintained on the electrodes during the time necessary to switch the foil between the “off” and the “on” state. In AM addressing, the voltage can be written on the pixel circuit, which will then maintain the correct voltage difference between the electrodes and induce foil switching. In other words, the next row of pixels can already be addressed while the foil sections associated with the first row are still in the process of crossing over from “off” to “on”.

In a foil display, the electrodes on the two plates and on the foil are located in very close proximity to each other (μm-distance), thus the pixels incur a considerable capacitance. With a PM-addressing scheme, the entire column (or row) of capacitances is charged when the voltages on the electrodes are changed. In AM-addressing, the power consumption can be significantly reduced since only the pixels that are addressed are being charged. Depending on the addressing scheme and the gray scaling method, the number of pulses can be reduced, which also leads to lower power consumption.

Another advantage is that because AM-addressing is more robust than PM-addressing, analog gray scaling—or partly analog gray scaling—becomes feasible. According to the invention, addressing electrodes are only required on either the light guide or the back plate. However, an unstructured electrode may be provided on the other plate (light guide or back plate, depending on where the addressable electrodes are arranged), in order to provide a biasing force in the form of a constant electrostatic force acting on the flexible element. The electrostatic force created by the addressable electrodes is then adapted to overcome this attraction, and to pull the foil towards the addressable electrodes.

According to a preferred embodiment, the biasing force is a mechanically induced force, for example an elastic force created by simply removing any spacers between the flexible element and the plate without addressing electrodes. The electrostatic force created by the addressable electrodes is then adapted to overcome this biasing elastic force.

By thus completely eliminating the electrode from the second plate (light guide or back plate, depending on where the addressable electrodes are arranged), the foil is not subjected to any electric field between the electrode layer and this plate, thus avoiding any electrostatic static charging phenomena on the second plate. Also, the balance of two large electrostatic forces for the foil position and foil switching control, requiring higher drive voltages, is avoided. Furthermore it is likely for the spread of the foil switching characteristics between various pixels to be reduced.

The addressing electrodes are preferably arranged on the back plate. The biasing force can then force the flexible element into contact with the light guide, and the addressing electrodes can be used to release selected portions of the element from the light guide, thereby turning them OFF.

When the addressing electrodes are placed on the back plate, this facilitates a minimization of light losses in the light guide plate which may otherwise be incurred through some degree of light absorption in or light scattering by the electrode material, and a higher brightness and uniformity can thus be achieved. This advantage is of particular importance when the flexible element is mechanically biased against the light guide (see above), since no electrode layer is then required on the light guide.

Further, the distance between the back plate and the flexible element, and hence between the two plates, can be chosen larger, as there is no need for the flexible element to make contact with the addressing electrodes. With an increased cell gap between the light guide and the back plate the foil switching behaviour in this design is less sensitive to disturbances caused by trapped dust particles. This, in turn, will reduce the requirements on the required clean room facilities for the fabrication of the display. It is important to note, however, that an increased spacer height requires a higher voltage difference in order to enable foil release from the light guide.

Instead of, or in combination with, the increased distance between flexible element and back plate, an elastic layer can be arranged between the flexible element and the back plate, in order to press the element against the light guide and thereby improve contact between them. The elastic layer further avoids large displacements of the flexible element from the light guide plate, as a complete crossing from the light guide plate to the back plate does not occur. A displacement bringing the foil outside the evanescent field of the light guide plate is sufficient to prevent extraction of light out of the light guide. Consequently, the collision impact of the foil onto the light guide plate that accompanies a pixel switching into the “on” state is much reduced, thus reducing the occurrence of wear and tribo-charging.

The elastic layer between the flexible element and the back plate (and thus the spacers on the back plate) can be made several micrometers thick. This decreases the sensitivity of the foil switching in a pixel to the presence of small contaminant particles on the foil and/or on the back plate surface facing the foil.

Alternatively, the addressable electrodes are arranged on the light guide. The flexible element is then biased away from the light guide, and the addressable electrodes are used to bring it into contact with the light guide, thereby turning the pixel ON.

In this case, the force of a attraction between the electrodes on the light guide and the electrode on the flexible element will contribute to ensure good optical contact between the flexible element and the light guide. In order to shield the light guide from any optical losses, a reflective layer can be locally arranged underneath the electrodes.

These and other aspects of the present invention will now be described in more detail, with reference to the appended drawings showing currently preferred embodiments of the invention.

FIG. 1 illustrates the switching principles of a pixel in a foil display of conventional kind.

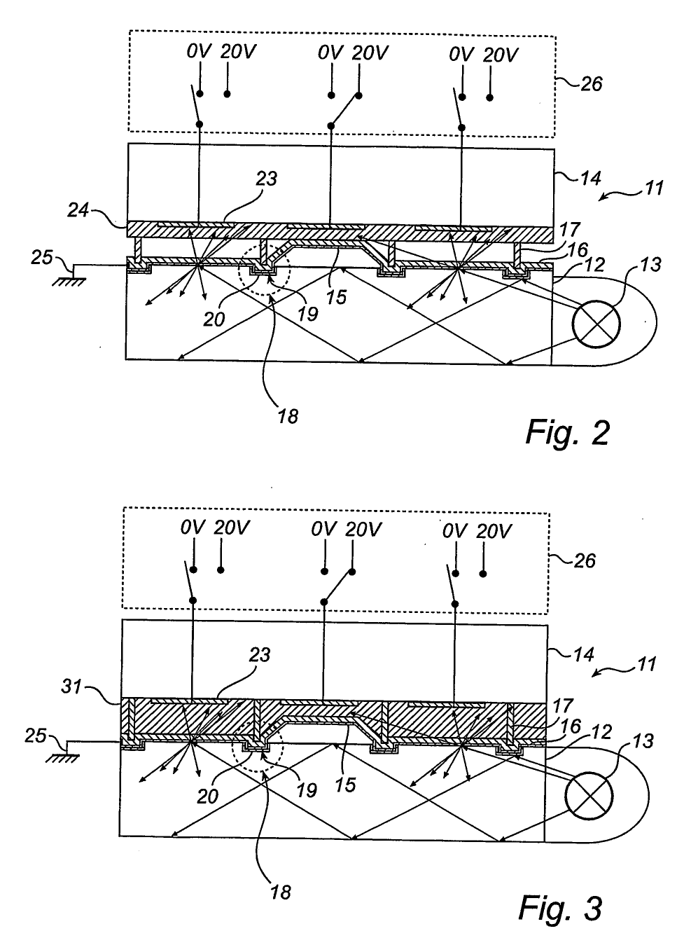

FIG. 2 schematically shows a cross section of a first embodiment of a display device according to the invention.

FIG. 3 schematically shows a cross section of a second embodiment of a display device according to the invention.

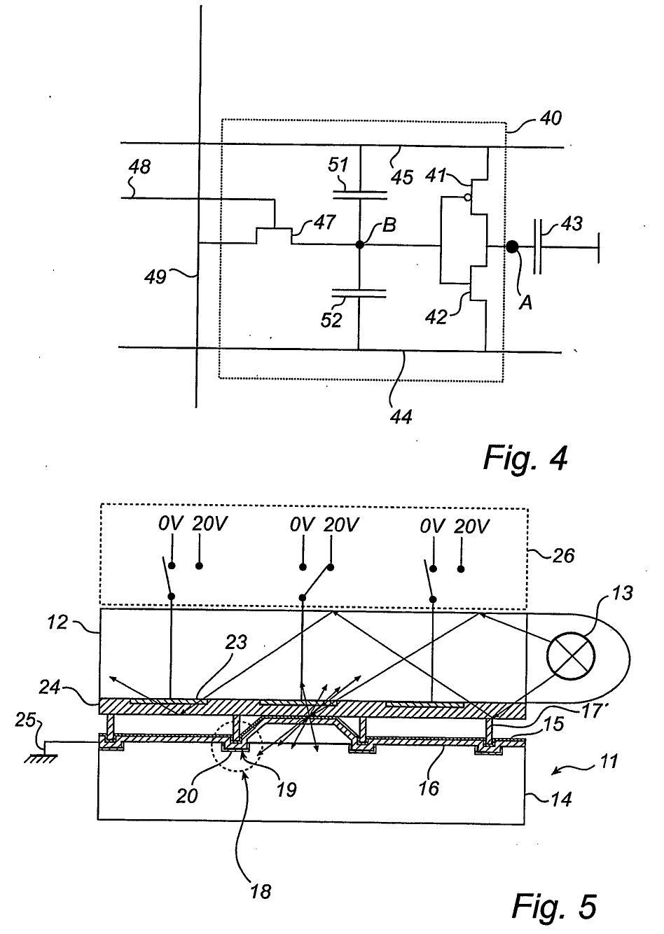

FIG. 4 schematically shows a pixel circuit suitable for a display device according to the invention.

FIG. 5 schematically shows a cross section of a third embodiment of a display device according to the invention.

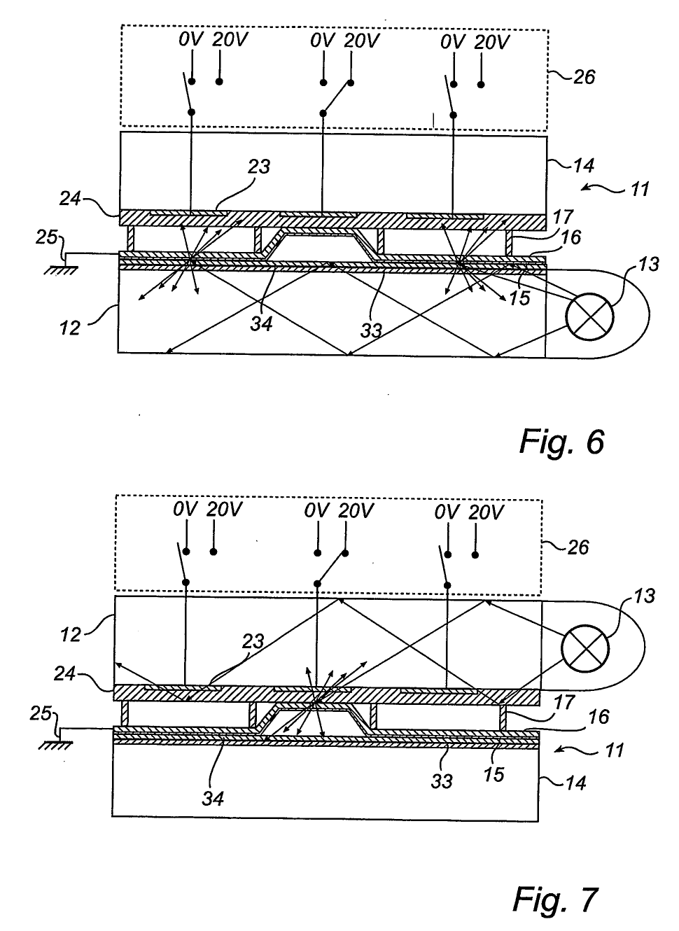

FIG. 6 schematically shows a cross section of a fourth embodiment of a display device according to the invention.

FIG. 7 schematically shows a cross section of a fifth embodiment of a display device according to the invention.

FIG. 8 schematically shows a cross section of a thin film transistor (TFT) implemented in a foil display according to FIG. 2.

FIG. 2 shows a foil display device 11 according to an embodiment of the invention. The display comprises a light guide (active plate) 12, connected to a light source 13, such as a LED, a back plate (passive plate) 14, and a flexible element clamped in between these plates. The flexible element can be a foil 15 of a flexible, light scattering material, such as an organic parylene foil containing scattering inorganic TiO₂ particles, with an unstructured foil electrode layer 16 disposed thereon. Spacers 17 are arranged between the back plate 14 and the foil 15, but contrary to a conventional foil display, no spacers are required on the other side of the foil. As a result, the foil 15 is pushed against the light guide 12. The design of the spacers 17 and the light guide 12 in the areas of contact 18 are optimized to achieve a large elastic force directed towards the light guide. In the illustrated example the light guide 12 has indentions 19 receiving the spacers 17, to thereby create a suitable elastic force. Further, at the places 18 where the spacers 17 keep the foil in contact with the light guide 12, a reflecting layer 20, of e.g. aluminum or silver, can be arranged.

Good optical contact between the foil 15 and the light guide 12 is achieved through a van der Waals adhesion of a controlled strength. The strength of this adhesion can be tuned e.g. through an appropriate adjustment of both the surface density of scattering particles that protrude from the foil surface facing the light guide, and the protrusion distance from the foil. Alternatively, the adhesion strength can be tuned by assigning a controlled surface roughness to the foil side facing the light guide. Also the deformation characteristics of the light guide surface plays a role in this regard.

The back plate 14 is provided with addressing electrodes 23, arranged to be capable of applying a positive voltage to a pixel element of the back plate 12. The electrodes can be formed by a transparent ITO layer, covered by an insulating layer 24. The foil electrode 16 is connected to ground potential 25. The addressing electrodes 23 are addressed by addressing means 26, which will be described in more detail below.

As the foil is kept in contact with the light guide, each pixel has a default state of ON. When an appropriate voltage difference is applied between the foil electrode and the corresponding addressing electrode, an electrostatic force is generated between the addressing electrode and the foil, which overcomes the Van der Waals force and the elastic force and releases the foil from the light guide. The pixel is thus turned OFF. The movement and position of the foil is controlled by the balancing of the elastic force and the electrostatic force. A local non-contact area (not shown) can be provided between the foil and the light guide within the pixel confinement area, to ensure that the foil releases from the light guide in the course of a lateral peeling process. Local outcoupling of light from the light guide by the foil at those positions 18 where the foil is permanently clamped onto the light guide through the presence of spacers 17 on the back plate is prevented by the specular-reflective patches 20.

A possibility for gray scales generation comes from the modulation of the amplitude of the voltage pulse imposed on the pixel electrodes, as this affects the width of the optical contact area of the foil on the light guide, and thereby the intensity of the emitted light from a pixel. Generally speaking, gray scales can be obtained by a combination of pulse width modulation (time modulation) and pulse height modulation (foil/light guide contact area modulation inside the pixels).

According to a further embodiment, illustrated in FIG. 3, an elastic layer 31 is arranged in between the foil and the addressing electrodes.

The elastic layer 31 can be made of a spongy organic material with an open cell structure and a high (>80%) porosity. At a thickness of a few μm, the pressure required to contract this layer by about 100 nm should be comparable to that of deflecting the foil 15 by about 100 nm in a given pixel confinement and thus spacer pitch.

According to this embodiment, the final location and shape of the foil results from the balance between the applied electrostatic force on the one hand and the opposing elastic force in the compressed porous layer and the elastic force in the foil on the other hand. In case the separation between the foil and the light guide is made to exceed a few hundred nm, no light is locally extracted and the pixel is in the “off” state. In case the separation between the foil and the light guide plate is adjusted between 30 nm and 100 - 150 nm, the evanescent field of the light guide only partly couples with the foil medium, thus creating the possibility of analog gray scale formation.

As the elastic layer 31 provides insulation between the addressable electrodes 23 and the foil electrode 16, no insulation layer 24 is required.

The addressing electrodes 23 in FIGS. 2 and 3 are preferably addressed by means of active matrix addressing. Such addressing may be provided by means of thin film transistor (TFT) switches 35 arranged on the back plate 14 and connected to each addressing electrode 23, as illustrated in FIG. 8. The TFT 35 shown in FIG. 8 is a bottom gate TFT. The TFT has two source drain electrodes 36, 37 and a bottom gate electrode 38. The first electrode 36 is connected to the transparent pixel electrode 23, the other electrode 37 is connected to a power line (not shown in FIG. 8). An insulating layer 39 covers the bottom gate 38, while the insulating layer 24 covers the entire TFT 35 and electrode structure 23.

The area of a foil display pixel is typically 200 μm by 600 μm—three pixels make a RGB pixel. The area covered by the TFT 35 is very small compared to the pixel area, approximately about 2% in a typical case. The height of the TFT stack 35 is approximately 500 nm, which is about half the height of the spacers 17. It is thus possible to place the TFTs 35 in such a way (e.g. in the corner of a pixel) so as to not affect the optical performance dramatically. As will be mentioned below, the TFT 35 may be placed either on the active or on the passive plate (light guide or back plate).

As mentioned above, AM addressing can make very fast addressing possible. However, if only a single TFT-switch per pixel is used without a power-line, due to the capacitance change of the pixel when crossing from the “off” to the “on” state, such fast addressing is not possible. FIG. 4 shows a pixel circuit more suitable for the display according to the invention.

The circuit 40 comprises two drive transistors 41, 42 of different type, i.e. PMOS and NMOS, having their drains connected to the pixel capacitance 43, i.e. the addressing electrode. The transistor sources are each connected to a different power line 44, 45, the first carrying a zero voltage, the second carrying a positive voltage, e.g. 20 V. The gates of the transistors 41, 42 are connected to the drain of a selection transistor 47, the gate of which is connected to a row selection line 48. The source of the selection transistor is connected to a column data line 49. Further, a first capacitor 51 is provided between the drain of the selection transistor 47 and the positive voltage power line 45, and a second capacitor is provided between the drain of the selection transistor 47 and the grounded power line 44.

Rows are selected with a 40V pulse on the row selection line 48, which makes it possible to write data on the column data line 49 to point B. Two capacitors 51 and 52 are used to fix the voltage level at point B. Through the combination of a PMOS and NMOS switches, the voltage is sourced or sunk from the two corresponding power lines 44, 45 to point A. In the illustrated example, a high signal on the column data line results in a low signal in point A. The same function can be realized by a complimentary circuit replacing PMOS with NMOS and NMOS with PMOS. Proper choice of the row voltage levels is necessary.

The circuit of FIG. 4 can be implemented in a CMOS circuit. In order to simplify the circuit, and to allow implementation with amorphous silicon technology, a two-transistor circuit, known per se, can be used. The TFT in FIG. 8 is an example of such an implementation. Compared to the circuit in FIG. 4, components 51, 45 and 41 are removed. Further, arrangements must be made to allow for external switching of the power line 44 between different values.

Before frame inversion, a reset pulse has to be given to all pixels. Inclusion of frame inversion in the driving scheme is possible, but adds complexity. Grey scales can be achieved with pulse width modulation.

According to the above embodiments, the addressing electrodes 23 and TFTs 35 are arranged on the back plate 14, while the light guide 12 has no electrodes. This minimizes the optical disturbance of the light guide. However, a potential drawback is that the TFT has to be manufactured/processed on top of the color filter layer (which requires planarization) or underneath the color filter layer (which requires higher voltages).

According to a further embodiment, shown in FIG. 5, the design of the display in FIG. 2 is reversed. In other words, the addressing electrodes 23 (and TFTs 35) are arranged on the light guide 12, and spacers 17′ are arranged to separate the foil 15 from the light guide 12.

The foil 15 does not have to make contact with the back plate 14, even though this is the case in the example shown. According to this embodiment, the default state of a pixel is OFF. By applying a voltage difference between the addressing electrodes and the foil, the elastic force is overcome, and the foil 15 is attracted to the light guide 12, to turn the pixel ON. The electrostatic force itself will ensure satisfactory optical contact between the foil 15 and the light guide. In this case, a reflective layer, such as an Al layer, can be arranged underneath the TFTs 35, in order to minimize optical losses. This has been indicated by numeral 32 in FIG. 8, in the case where the TFT 35 is arranged on a light guide 12. Note, however, that the layer 32 in FIG. 8 is illustrated as extending into the glass plate 12, while in reality it would be disposed on top of the glass plate 12, leading to a slight displacement of the TFT stack 35.

According to still another embodiment, the biasing force acting on the foil is also an electrostatic force, generated by an unstructured electrode 33 arranged on the opposite side of the foil. The electrode, e.g. an ITO layer 33, is covered by an insulating layer 34. In FIG. 6, such an unstructured electrode 33 is arranged on the light guide 12, and in FIG. 7 it is arranged on the back plate 14. In both cases, spacers (not shown) can be arranged on both sides of the foil 15, as there is no longer a need to create the elastic force mentioned above. In FIG. 7, the back plate 14 is provided only with a color filter layer and an unstructured ITO electrode 33. Such color filters with unstructured ITO are readily commercially available.

The present invention is not limited to the above description of preferred embodiments. On the contrary, the skilled man realizes that numerous modifications and alternatives are possible within the scope of the appended claims. For example, instead of active matrix addressing, the display can be addressed one line at a time, by arranging the foil to extract light from the light guide one row at a time. By arranging for amplitude modulation of the light guide, such an addressing scheme can also be implemented to achieve gray scaling. The details of such an addressing scheme are disclosed in PHNL021414 (EP Application number 02080543.8), hereby enclosed by reference.

1. A display device comprising a light guide (12), a back plate (14), a flexible element (15) arranged in between said light guide (12) and said back plate (14), and addressable electrodes (23) for inducing electrostatic forces on said element (15) and for bringing selected portions of said element (15) into contact with said light guide (12), in order to extract light from said light guide (12), characterized in that said addressable electrodes (23) are arranged only on one of said light guide (12) and said back plate (14), and that a biasing force acts on said flexible element (15) in a direction away from said addressable electrodes (23).

2. A display device according to claim 1, wherein said addressable electrodes (23) are addressed using active matrix addressing.

3. A display device according to claim 2, wherein thin film transistors (TFT) (35) are used to address the electrodes (23).

4. A display device according to claim 1, wherein said element (15) is electrostatically biased away from the addressing electrodes (23).

5. A display device according to claim 1, wherein said element (15) is mechanically biased away from the addressing electrodes (23).

6. A display device according to claim 5, further comprising an elastic layer (31) between the flexible element (15) and the addressable electrodes (23).

7. A display device according to claim 1, wherein said addressable electrodes (23) are arranged on the back plate (14).

8. A display device according to claim 1, wherein said addressable electrodes (23) are arranged on the light guide (12).

9. A display according to claim 8, wherein a reflective layer (32) is arranged underneath the TFT (35).
